(19) United States
(12) Patent Application Publication
(10) Pub. No.: US 2023/0180086 A1
(43) Pub. Date: Jun. 8, 2023

(54) METHOD AND APPARATUS FOR ACCESSING NETWORK CELL

(71) Applicant: Samsung Electronics Co., Ltd., Suwon-si, Gyeonggi-do (KR)

(72) Inventor: Dasheng LI, Guangzhou (CN)

(21) Appl. No.: 17/926,013

(22) PCT Filed: Jan. 29, 2021
(86) PCT No.: PCT/KR2021/001199

§ 371 Date: Nov. 17, 2022

(30) Foreign Application Priority Data
May 22, 2020 (CN) 202010439781.X

(51) Int. Cl. H04W 36/18; H04W 36/32

(52) U.S. Cl. CPC H04W 36/18; H04W 36/32

(57) ABSTRACT

A method and apparatus for accessing a network cell are provided. The method for accessing, by a mobile terminal, the network cell comprises: obtaining location information of the mobile terminal; obtaining second area information, before the mobile terminal arrives at a first area; and performing a network cell search and accessing a searched network cell based on the obtained second area information, in response to detecting that the mobile terminal enters the second area, wherein, the first area is an area without network service or an area with weak network service, and the second area is an area with normal network service on a travel route of the mobile terminal, and the mobile terminal enters the second area after passing through the first area, thereby improving the network cell access efficiency of the mobile terminal.

### CROSS-REFERENCE TO RELATED APPLICATION(S)

This application is a U.S. National Stage Application under 35 U.S.C. § 371 of an International application number PCT/KR2021/001199, filed on Jan. 29, 2021, which is based on and claims priority of a Chinese patent application number 202010439781.X, filed on May 22, 2020, in the Chinese Intellectual Property Office, the disclosure of which is incorporated by reference herein in its entirety.

### TECHNICAL FIELD

The present disclosure relates to the technical field of mobile communication. More specifically, the present disclosure relates to a method and apparatus for accessing a network cell.

### BACKGROUND ART

A continuous network optimization is necessary for a mobile communication network. The planning and optimization of base station in the cellular mobile network aims at providing appropriate base station parameters and achieving full coverage of network cell signals to improve the quality of network service. The problems, such as poor signal quality, strong signal interference in the area, or signal dead zones, etc. caused by various practical reasons in the process of actually deploying the cellular wireless network may greatly impact user’s experience of using the mobile network. Network operators may generally perform the optimization and adjustment of the mobile network over a long time period for a variety of practical reasons.

After entering a cellular network cell, the mobile terminal may start to search for frequency point information of the current network cell and read broadcast information of the network cell based on the network standard supported by the mobile terminal, the frequency band support capability of the mobile terminal, and the user’s expected settings, etc. The mobile terminal which meets the conditions for residing in the network cell may register with the mobile network to obtain normal network services. During continuous moving of the mobile terminal, such as from network cell Cell A to network cell Cell B, in the case that the network cell Cell B cannot meet conditions for the mobile terminal residing in the network cell Cell B or there is a network coverage dead zone between the network cell Cell A and the network cell Cell B, the mobile terminal may enter an out of service (OOS) status. The mobile terminal may start a timer to periodically scan all frequency points in the whole frequency band at regular time. When finding the frequency points of the network cell with good signal quality and permission for accessing, the mobile terminal may stop the timer and obtain normal network services. Currently, most of the mobile terminals may support multiple network standards. A lot of network standards, frequency bands, and frequency points may be supported by the mobile terminals. The mobile terminal may spend a lot of time and power to scan network frequency points one by one in the whole frequency band, which leads to longer time for restoring the network services and worse user experience.

### DISCLOSURE

### Technical Problem

Exemplary embodiments of the present disclosure are to provide a method and apparatus for accessing a network cell, to improve the network cell access efficiency of the mobile terminal.

### Technical Solution

According to an exemplary embodiment of the present disclosure, a method accessing by a mobile terminal, a network cell is provided, comprising: obtaining location information of the mobile terminal; obtaining second area information, before the mobile terminal arrives at a first area; and performing a network cell search and accessing a searched network cell based on the obtained second area information, in response to detecting that the mobile terminal enters the second area, where, the first area is an area without network service or an area with weak network service, and the second area is an area with normal network service on a travel route of the mobile terminal, and the mobile terminal enters the second area after passing through the first area.

According to an exemplary embodiment of the present disclosure, an apparatus of a mobile terminal for accessing a network cell is provided, comprising: a processor; and a memory storing a computer program, wherein the computer program, when executed by the processor, causes the processor to perform operations comprising: obtaining location information of the mobile terminal; obtaining second area information, before the mobile terminal arrives at a first area; and performing a network cell search and access a searched network cell based on the obtained second area information, in response to detecting that the mobile terminal enters the second area, wherein, the first area is an area without network service or an area with weak network service, and the second area is an area with normal network service on a travel route of the mobile terminal, and the mobile terminal enters the second area after passing through the first area.

The method and apparatus for accessing the network cell according to exemplary embodiments of the present disclosure, by obtaining location information of the mobile terminal; obtaining second area information, before the mobile terminal arrives at a first area; and performing a network cell search and accessing a searched network cell based on the obtained second area information, in response to detecting that the mobile terminal enters the second area, where, the first area is an area without network service or an area with weak network service, and the second area is an area with normal network service on a travel route of the mobile terminal, and the mobile terminal enters the second area after passing through the first area, the network cell access efficiency of the mobile terminal may be improved.

In the method and apparatus for accessing the network cell according to the exemplary embodiments of the present disclosure, artificial intelligence (referred as AI) technology is used to intelligently predict the target cell information and the arrival time of the mobile communication terminal in advance to help the mobile communication terminal to quickly restore network services, or automatically adapt to network changes, which may reduce waiting time of residing in the network, reduce unnecessary full-band scanning process, reduce battery power consumption, and improve the experience of the terminal user.

Additional aspects and/or advantages of the present disclosure will be set forth and become apparent in/from the description which follows, or may be learned by implementation of the embodiments in the description.

### DESCRIPTION OF DRAWINGS

The above and other objects and features of various exemplary embodiments of the present disclosure will become more apparent through the following detailed description in conjunction with the accompanying drawings which exemplarily show the embodiments, in which:

FIG. 1 shows a flowchart of a method for a mobile terminal to access a network cell according to an exemplary embodiment of the present disclosure;

FIG. 2 shows a scenario where a mobile terminal first registers with a 4G network, then falls back to a 3G network, and then returns to the 4G network during moving;

FIG. 3 shows a scenario where a mobile terminal first registers with a 4G network, then enters a signal dead zone which causes disconnecting from the 4G network, and then returns to the 4G network;

FIG. 4 shows a block diagram of an apparatus of a mobile terminal for accessing a network cell according to an exemplary embodiment of the present disclosure; and

FIG. 5 shows a schematic diagram of a computing apparatus according to an exemplary embodiment of the present disclosure.

### MODE FOR INVENTION

Reference will now be made in detail to exemplary embodiments of the present disclosure, examples of which are shown in the accompanying drawings, where the same reference numerals always refer to the same components. The embodiments will be described below in order to explain the present disclosure by referring to the accompanying drawings.

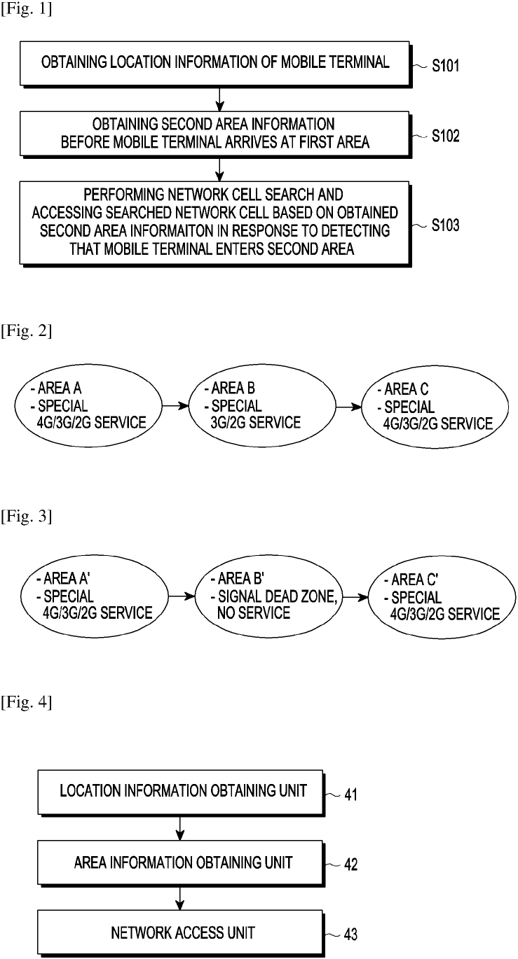

FIG. 1 shows a flowchart of a method for a mobile terminal to access a network cell according to an exemplary embodiment of the present disclosure. Here, the method for the mobile terminal to access the network cell shown in FIG. 1 is performed locally in the mobile terminal or in a server connected to the mobile terminal.

Referring to FIG. 1, in step S101, the method comprises obtaining location information of the mobile terminal.

In an exemplary embodiment of the present disclosure, after obtaining the location information of the mobile terminal, a first area and a second area to be passed through by the mobile terminal and first area information and second area information may be predicted based on historical trip feature data of the mobile terminal and the location information of the mobile terminal. Here, the first area may be an area without network service or an area with weak network service, and the second area may be an area with normal network service on a travel route of the mobile terminal, and the mobile terminal enters the second area after passing through the first area.

In an exemplary embodiment of the present disclosure, the historical trip feature data may comprise at least one of a route area, time information corresponding to the route area, route network information corresponding to the route area, user feature information, and traffic feature information.

In an exemplary embodiment of the present disclosure, the first area may be an area without network service or an area with weak network service, and the second area may be an area with normal network service on a travel route of the mobile terminal, and the mobile terminal enters the second area after passing through the first area.

In an exemplary embodiment of the present disclosure, the first area information comprises time required to pass through the first area under a preset condition, and the second area information comprises at least one of network cell information, network signal strength of the network cell, network coverage of the network cell, network connection speed, network type, and network access status of the second area. Here, the time required to pass through the first area under the preset condition may be, for example, but not limited to, the time required for the user of the mobile terminal (referred as the user) to pass through the first area by taxi, driving, bus, walking, bicycle, electric bicycle, or subway, etc. Here, in the case of walking, depending on a walking speed of the user and a route selected by the user, the time required to pass through the first area is varied.

In an exemplary embodiment of the present disclosure, the network cell information of the second area is information on a network cell which the mobile terminal prefers to access in the second area. For example, the access networks which the mobile terminals prefer to access are different for a Unicom user, a Mobile user, and a Telecom user.

In an exemplary embodiment of the present disclosure, different areas (for example, the first area and the second area) are divided by a critical line at which the network status changes.

In an exemplary embodiment of the present disclosure, when predicting the first area and the second area to be passed through by the mobile terminal and the first area information and the second area information, the first area and the second area to be passed through by the mobile terminal and the first area information and the second area information may be predicted when a condition for triggering the prediction is detected. Here, the condition for triggering the prediction comprises at least one of an expiration of a timing with a predetermined prediction period, a location change, a deviation from a trajectory, and a change in current network connection status.

For example, in the case that the predetermined prediction period is 1 hour, the prediction of the first area and the second area to be passed through by the mobile terminal and the first area information and the second area information is performed every 1 hour. If a location deviation of the mobile terminal from a previously predicted trajectory or a location change of the mobile terminal is detected (for example, according to the previously predicted trajectory, the mobile terminal should come out of exit A of a supermarket, but it is now detected that the mobile terminal is moving toward exit B of the supermarket), then the prediction of the first area and the second area to be passed through by the mobile terminal and the first area information and the second area information is performed, so that prediction errors are adjusted at any time based on the moving of the mobile terminal. If a change in the network connection status of the mobile terminal is detected, the prediction of the first area and the second area to be passed through by the mobile terminal and the first area information and the second area information is performed, so that the prediction errors are adjusted at any time based on the change of the network connection status the mobile terminal.

In an exemplary embodiment of the present disclosure, when predicting the first area and the second area to be passed through by the mobile terminal and the first area information and the second area information, the first area and the second area to be passed through by the mobile terminal and the first area information and the second area information may be predicted locally in the mobile terminal and/or in the server.

Specifically, the historical trip feature data may comprise various types of information collected from the current resident network cell or from the Internet by fully using existing communication technologies, comprising but not limited to the following information.

i. Network cell information, which is collected based on the current communication network scheme. During the process of the mobile terminal searching for a network cell and completing the operation of residing in the network cell, the network cell may notify the mobile terminal of the parameters of the current network cell through a system broadcast message, comprising but not limited to: PLMN (Public Land Mobile Network), LAC (Location Area Code)/TAC (Tracking Area Code), RAT (Radio Access Technologies), Cell ID (Cell Identity), PSC (Primary Scrambling Code)/PCI (Physical Cell Identity), ARFCN (Absolute Radio Frequency Channel Number), neighboring network cell information, etc. At the same time, the mobile terminal may periodically detect the network cell signal strength RSSI, RSCP/ECIO, RSRP, RSRQ, etc. received at the current location, and feedback the same to the mobile network for mobile scheduling.

ii. Mobile terminal information, which is only used to identify a specific mobile terminal. The collected mobile terminal information comprises but is not limited to: International Mobile Equipment Identity (IMEI), International Mobile Subscriber Identification Number (IMSI), etc. IMEI and IMSI are the globally unique identification information, which are uniquely assigned when the mobile terminal is produced and embedded in the mobile terminal. Different mobile terminals may be distinguished from each other with such information.

iii. User behavior information and user historical path information. The user behavior information comprises user habit information. The collected user habit information should not involve personal privacy. The user’s daily behavior habit may be identified only by the use status of the mobile terminal. The user behavior information and the user historical path information comprise but are not limited to: the location of the network cell where the user resides for a long time, the user’s main active area, the user’s regular movement path, the time period when the user frequently moves, the location where the network status changes repeatedly in the terminal, the reason why the network status change in the terminal, etc. Such information needs to be collected through an inductive statistical method. For example, in the case that there is no handover of the network cell for the mobile terminal and no significant change in signal strength within a certain time period, assisting GPS positioning function and other related information, if the time period is night and repeats for a long time, the user’s home residence may be summarized and identified. If the time period is daytime and repeats for a long time, the user’s work place may be summarized and identified. If the user moves from the home residence to the work place or from the work place to the home residence in almost the same time period every day, the user’s on duty route or off duty route may be summarized and identified. If the network cells passed through by the user during the on and off duty moving are connected in series, being assisted by the GPS positioning function, the user’s moving path may be summarized. If there is an area without network service in the user’s moving path, the mobile terminal needs to record information. The recorded information comprises but is not limited to entry location, entry time, recovery location, recovery time, mobile terminal status, etc. The collection of the user behavior information needs to be based on the current network status of the mobile terminal, the changed network status, location, time, status change, and other information that may be obtained using existing technical means. The collected user behavior information may be summarized and identified as a set of user behavior habits through a preset logic. The more extensive information collection leads to the more accuracy summarization of the user’s behavior habits, and the higher degree of intelligent prediction.

iv. Traffic road network information, which is used to perceive the accurate user route and required time during moving, comprising but not limited to: moving route, moving speed, road conditions ahead, used vehicle, time that may be required, etc. When the mobile terminal is constantly moving, it may continuously switch between different network cells. All the network cells passed through in the moving process are connected in series as the user’s moving path. Being assisted by the auxiliary GPS positioning information or network cell positioning information (similar to EGPS positioning) in combination with the network map information, the path is modified during the process, thereby depicting an accurate moving path of the user. For example, when the user moves from one network cell to another network cell, based on a calculated moving distance and time spent, the user’s moving speed may be inferred, which may further infer whether the user is riding or walking. Specific location information of the current mobile terminal can be obtained through GPS positioning information or network cell location information. Based on the current specific location information and the user’s moving path information, the path route that the user is using may be identified from the map. In combination with the use of existing road condition prediction information of network map, the road conditions ahead may be predicted and possible time to arrive at the destination may be calculated;

v. Other relevant information, which is more types of relevant information as possible collected from the Internet, comprising but not limited to: network cell change and adjustment noticed by the operator, a network cell with many user complaints, a known signal dead zone or an area with a extremely poor signal, impact of extreme weather, etc. The information that may affect a communication network, signal transmission, an existing problem, etc. may be collected as much as possible through automatic network search, user information sharing, operator information sharing and other technical means, thereby providing a reliable basis for prediction.

In step S 102, the method comprises obtaining the second area information before the mobile terminal arrives at the first area.

In an exemplary embodiment of the present disclosure, it may also be determined whether the mobile terminal arrives at the first area, based on a positioning result of the mobile terminal.

In an exemplary embodiment of the present disclosure, after the step of obtaining the second area information, it may also be detected whether the mobile terminal enters the second area, based on at least one of the positioning result of the mobile terminal, a network signal change of the mobile terminal, and time elapsed since the mobile terminal arrives at the first area.

Specifically, when predicting the first area and the second area to be passed through by the mobile terminal and the first area information and the second area information, a variety of information such as network cell information, user behavior information, Internet information, traffic road network information, mobile terminal information, and the like may be first analyzed. For example:

i. when analyzing the network cell information, the network parameters of the network cell in which the mobile terminal currently resides may be obtained;

ii. when analyzing the user behavior information, a set of user habits may be obtained and summarized through a pre-defined logic, based on network cells passed through by the mobile terminal and changes in the related statuses during the moving of the mobile terminal;

iii. when analyzing the Internet information, a scheme of web crawler may be used to download data at a specified address from the Internet. The information may be obtained and stored through a pre-defined rule. For example, the information may be collected through keyword matching and other rules;

iv. when analyzing the traffic road network information, network route information in the network map may be learned, real-time road condition information and other public transportation information may be collected, or information collected by using application programming interface (API) of a third-party map software may be learned; and

vi. when analyzing mobile terminal information, classification information of the mobile terminal information may be obtained. In addition, when analyzing other information, the information may be refined and stored according to a predefined classification method.

Specifically, when predicting the first area and the second area to be passed through by the mobile terminal, based on analysis results of the user behavior information, the traffic road network information, the mobile terminal information, etc., the road network in the map, the starting point location, the target location and other information may be learned to predict the user’s moving path. When predicting the first area information and the second area information, the network cell or area in which the network status changes in the forward direction of the moving path may be predicted based on the analysis results of the network cell information, the mobile terminal information, and the like. In addition, the distance and time when the mobile terminal moves from the current location to the target location may also be predicted. The network parameters of the target network cell may be input, such as the supported network standard, a set of frequency points, network cell identification and other information.

In an exemplary embodiment of the present disclosure, when predicting the second area information using a preset prediction model, model training may be performed in advance (for example, through a learning and training module in the prediction model).

In an exemplary embodiment of the present disclosure, when predicting the first area and the second area to be passed through by the mobile terminal and the first area information and the second area information in the mobile terminal locally, the predicted second area information may be stored before the mobile terminal arrives at the second area. When predicting the first area and the second area to be passed through by the mobile terminal and the first area information and the second area information in the server, the server may send the predicted second area information to the mobile terminal before the mobile terminal arrives at the second area.

In step S103, the method comprises performing a network cell search and accessing a searched network cell based on the obtained second area information, in response to detecting that the mobile terminal enters the second area.

Specifically, if it is detected that the mobile terminal enters the second area, it means that the mobile terminal is entering an area with normal network service from an area without network service or an area with weak network service. Under the circumstance, a network search needs to be performed again to access the network.

Specifically, the mobile terminal may start a timer T1 to calculate the time required for arriving at the target network cell. When the timer T1 expires, the mobile terminal starts a timer T2 to perform a network cell search based on frequency point information provided by the network information of the target network cell, to find a suitable network cell and obtain network service. By this time, the mobile terminal stops the timer T2.

In an exemplary embodiment of the present disclosure, after accessing the network, the preset prediction model may also be updated based on network cell information of the network which the mobile terminal currently accesses and the current location of the mobile terminal.

FIG. 2 shows a scenario where a mobile terminal first registers with a 4G network, then falls back to a 3G network, and then returns to the 4G network during moving.

In FIG. 2, area A, area B, and area C do not specifically refer to a single network cell, but may be a collection of a plurality of network cells.

Referring to FIG. 2, the mobile terminal resides in a 4G network cell of area A and obtains network service at the beginning of the moving path. The mobile terminal in area A may predict that the network status may change when it moves from area A to area B (switching from 4G network to 3G network), and calculate the time for the mobile terminal to arrive at area B and information on the accessible network cell. Meanwhile, the mobile terminal may predict that the mobile terminal may arrive at area C after passing through area B, and that the network status may also change in area C (switching from the 3G network to the 4G network), and calculate the possible time period for the mobile terminal to arrive at area C and network cell information. When the mobile terminal arrives at area B during moving, it obtains network services based on the prediction for area B in area A, and collects information of the current resident network cell and learns and feed backs the collected information for subsequent prediction. Then the mobile terminal may predict, in area B, that the network status may change when it arrives at area C, and calculate the time for arriving at area C and information on the accessible network cell, and modify and adjust the previous prediction result. When the mobile terminal arrives at area C during moving, it may obtain network services based on a prediction result for area C in area B, and collect information of the current resident network cell and learns and feed backs the collected information for subsequent prediction.

FIG. 3 shows a scenario where a mobile terminal first registers with a 4G network, then enters a signal dead zone which causes disconnecting from the 4G network, and then returns to the 4G network.

In FIG. 3, area A′, area B′, and area C′ do not specifically refer to a single network cell, but may be a collection of a plurality of network cells.

Referring to FIG. 3, the mobile terminal resides in a 4G network cell of area A′ and obtains network services at the beginning of the moving path. The mobile terminal in area A′ may predict that the network status may change when it moves from area A′ to area B′ (switching from 4G network to out of network service), and calculate the time for the mobile terminal to arrive at area B′ and the time period it may stay in area B′. Meanwhile, the mobile terminal may predict that it may also arrive at area C′ after passing through area B′, and that the network status may also change in area C′ (restoring from out of network service to 4G network), and calculate the possible time period for the mobile terminal to arrive at area C′ and the network cell information. When the mobile terminal arrives at area B′ during moving, the network status is switched to out of network service status, and the mobile terminal calculates the time to arrive at area B′ and the current network status and stores the same locally. Then a timer is started in area B′ to detect network cell information of area C′ based on the prediction results for area B′ and area C′ in area A′. In this process, the mobile terminal prefers to detect a set of frequency points in the prediction result for area C′ in area A′. When the mobile terminal detects a 4G network cell in area C′ and obtains network services, it collects information of the current resident network cell and the time to arrive at area C′, and learns and feed backs the collected information of the current resident network cell and the time to arrive in area C′ and the stored time to arrive at area B′ and the stored network status information of area B′ for subsequent prediction.

When the mobile terminal locally performs the method for the mobile terminal to access the network cell, for example, the mobile terminal may first obtain current resident network cell information, network cell information, mobile terminal information, user behavior information, traffic road network information, other relevant information, etc. Then the mobile terminal, for example, through a learning and training module in the prediction model, perform learning and training on the obtained information, predict the moving path of the mobile terminal based on the current resident cell information, and at the same time calculate the information of the target network cell in which network status changes and the time to arrive at the target cell, etc., and detect status information of the resident network cell on time. When the network status changes, a network search module is started to detect the frequency points of the target cell. When the mobile terminal successfully resides in the target network cell, the current resident target network cell information is stored for subsequent learning and training.

When the server connected to the mobile terminal performs the method for the mobile terminal to access the network cell, for example, the mobile terminal may first obtain current resident network cell information, network cell information, mobile terminal information, user behavior information, traffic road network information, other relevant information, etc., and then send the obtained information to the server. The server (for example, through a learning and training module in the prediction model) performs learning and training on the information, and predicts the moving path of the mobile terminal based on the current resident cell information, and at the same time calculates the information of the target network cell in which the network status changes, the time to arrive at the target cell, etc., to obtain prediction data and send the prediction data to the mobile terminal. The mobile terminal detects status information of the resident network cell based on the prediction data. When the network status changes, a network search module is started to detect the frequency points of the target cell. When the mobile terminal successfully resides in the target network cell, it feeds back the current resident target network cell information to the server for subsequent learning and training.

Specifically, the learning and training module may comprise sub-modules such as a network cell information learning module, a traffic road network learning module, a user behavior learning module, an Internet information learning module, a terminal information learning module, and other information learning modules. An information prediction module comprises sub-modules such as a user path prediction module, a network status change prediction module, and a target information prediction module.

i. Network cell information learning sub-module, which learns the network parameters of the current resident network cell of the communication terminal. For the collection range of the related network parameters, please refer to the introduction of the above user information collection module;

ii. User behavior habit learning sub-module, which, based on the cells passed through by the communication terminal during moving and the change in the related status, summarize a set of user habits through a pre-established logic. For the method for summarizing the set of user habits, please refer to the introduction of the above user information collection module;

iii. Internet information learning sub-module, which downloads data at a specified address from the Internet by using the scheme of web crawler, obtains and stores the information through a pre-defined rule, such as using keyword matching and other rules to collect the information;

iv. Terminal information learning sub-module, which may learn mobile terminal information;

v. Other information learning sub-modules, the collected information is mainly from the Internet, and is refined and stored according to a predefined classification method;

vi. Traffic road network information learning sub-module, which learns the road network route information of the network map, collects real-time road condition information and other public transportation information, or collects the information using a third-party map software API;

vii. User path prediction sub-module, which may predict the user’s moving path by using the road network information the map, the starting point position, the target location and other information of the terminal information learning sub-module, the traffic road network information learning sub-module, the user behavior habit learning sub-module;

viii. Network status change prediction sub-module, which may predict the network cell or area in which the network status changes in the forward direction of the moving path, by using the routes of the network cell information learning sub-module, the terminal information learning sub-module, and the user path prediction sub-module, and using the information of the network cells connected in series in the route;

ix. Target information prediction sub-module, which may predict the distance and time when the communication terminal moves from the current location to the target location may be predicted, by using the network status change prediction module, the route of the user path prediction module, and the target cell where the network status changes. The network parameters of the target cell may be input, such as the supported network standard, the set of the frequency points, the cell identification and other information.

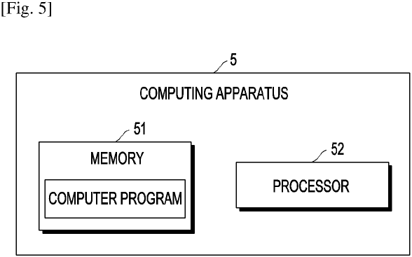

The method for the mobile terminal to access the network cell according to the exemplary embodiments of the present disclosure has been described above with reference to FIGS. 1 to 3. Hereinafter, an apparatus of a mobile terminal for accessing a network cell and its units according to an exemplary embodiment of the present disclosure will be described with reference to FIG. 4.

FIG. 4 shows a block diagram of an apparatus of a mobile terminal for accessing a network cell according to an exemplary embodiment of the present disclosure.

Referring to FIG. 4, the apparatus of the mobile terminal for accessing the network cell comprises a location information obtaining unit 41, an area information obtaining unit 42, and a network access unit 43.

The location information obtaining unit 41 is configured to obtain location information of the mobile terminal.

In an exemplary embodiment of the present disclosure, the apparatus of the mobile terminal for accessing the network cell may further comprise an information prediction unit (not shown), configured to predict a first area and a second area to be passed through by the mobile terminal and first area information and second area information, based on historical trip feature data of the mobile terminal and the location information of the mobile terminal. Here, the historical trip feature data may comprise at least one of a route area, time information corresponding to the route area, route network information corresponding to the route area, user feature information, and traffic feature information. Here, the first area may be an area without network service or an area with weak network service, and the second area is an area with normal network service on a travel route of the mobile terminal, and the mobile terminal enters the second area after passing through the first area.

In an exemplary embodiment of the present disclosure, the information prediction unit may be configured to predict the first area and the second area to be passed through by the mobile terminal and the first area information and the second area information when a condition for triggering the prediction is detected. Here, the condition for triggering the prediction may comprise at least one of an expiration of a timing with a predetermined prediction period, a location change, a deviation from a trajectory, and a change in current network connection status.

In an exemplary embodiment of the present disclosure, the information prediction unit may be configured to predict the first area and the second area to be passed through by the mobile terminal and the first area information and the second area information in a server and/or in the mobile terminal locally.

In an exemplary embodiment of the present disclosure, the first area information may comprise time required to pass through the first area under a preset condition, and the second area information may comprise at least one of network cell information, network signal strength of the network cell, network coverage of the network cell, network connection speed, network type, and network access status of the second area. Here, the network cell information of the second area is information on a network cell which the mobile terminal prefers to access in the second area.

The area information obtaining unit 42 is configured to obtain the second area information before the mobile terminal arrives at the first area.

In an exemplary embodiment of the present disclosure, the apparatus of the mobile terminal for accessing the network cell may further comprise a determination unit (not shown) configured to determine whether the mobile terminal arrives at the first area based on the positioning result of the mobile terminal.

The network access unit 43 is configured to perform a network cell search and access a searched network cell based on the obtained second area information, in response to detecting that the mobile terminal enters the second area.

In an exemplary embodiment of the present disclosure, the apparatus of the mobile terminal for accessing the network cell may further comprise: an area detection unit (not shown) configured to detect whether the mobile terminal enters the second area, based on at least one of a positioning result of the mobile terminal, a network signal change of the mobile terminal, and time elapsed since the mobile terminal arrives at the first area.

In addition, according to an exemplary embodiment of the present disclosure, a computer readable storage medium storing a computer program therein is also provided, wherein the computer program, when executed, implements the method for the mobile terminal to access the network cell according to an exemplary embodiment of the present disclosure.

In an exemplary embodiment of the present disclosure, the computer readable storage medium may carry one or more computer programs, wherein the computer program(s), when executed, may implement the following steps: obtaining location information of the mobile terminal; obtaining second area information, before the mobile terminal arrives at a first area; and performing a network cell search and accessing a searched network cell based on the obtained second area information, in response to detecting that the mobile terminal enters the second area, where, the first area is an area without network service or an area with weak network service, and the second area is an area with normal network service on a travel route of the mobile terminal, and the mobile terminal enters the second area after passing through the first area, thereby improving the network access efficiency of the mobile terminal.

The computer readable storage medium may be, for example, but not limited to: electric, magnetic, optical, electromagnetic, infrared, or semiconductor systems, apparatus, elements, or a combination of any of the above. A more specific example of the computer readable storage medium may comprise but is not limited to: electrical connection with one or more wires, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the embodiments of the present disclosure, the computer readable storage medium may be any physical medium containing or storing computer programs which may be used by a command execution system, apparatus or element or incorporated thereto. The computer programs embedded in the computer readable storage medium may be transmitted with any suitable medium comprising but not limited to: wired, optical cable, RF (radio frequency), etc., or any suitable combination of the above. The computer readable storage medium may be comprised in any apparatus. It may also exist alone without being assembled into the apparatus.

The apparatus of the mobile terminal for accessing the network cell according to an exemplary embodiment of the present disclosure is described above with reference to FIG. 4. Next, a computing apparatus according to an exemplary embodiment of the present disclosure is described with reference to FIG. 5.

FIG. 5 shows a schematic diagram of a computing apparatus according to an exemplary embodiment of the present disclosure.

Referring to FIG. 5, the computing apparatus 5 according to an exemplary embodiment of the present disclosure comprises a memory 51 and a processor 52. The memory 51 stores a computer program, wherein the computer program, when executed by the processor 52, implements the method for the mobile terminal to access the network cell according to an exemplary embodiment of the present disclosure.

In an exemplary embodiment of the present disclosure, the computer program, when executed by the processor 52, may implement the following steps: obtaining location information of the mobile terminal; obtaining second area information, before the mobile terminal arrives at a first area; and performing a network cell search and accessing a searched network cell based on the obtained second area information, in response to detecting that the mobile terminal enters the second area, where, the first area is an area without network service or an area with weak network service, and the second area is an area with normal network service on a travel route of the mobile terminal, and the mobile terminal enters the second area after passing through the first area, thereby improving the network cell access efficiency of the mobile terminal.

The computing apparatus in the embodiment of the present disclosure may comprise but is not limited to apparatus such as mobile phone, notebook computer, PDA (personal digital assistant), PAD (tablet computer), and the like. The computing apparatus shown in FIG. 5 is only an example, and should not impose any limitation to the functions and scope of use of the embodiments of the present disclosure.

The method and apparatus for accessing the network cell according to the exemplary embodiments of the present disclosure have been described above with reference to FIGS. 1 to 5. However, it should be understood that the apparatus and its units for the mobile terminal to access the network cell shown in FIG. 4 may be respectively configured as software, hardware, firmware, or any combination of the above items for performing specific functions. The computing apparatus shown in FIG. 5 comprises, but is not limits to, the components shown above. Some components may be added or deleted as needed, and the above components may also be combined.

In the exemplary embodiment of the present disclosure, at least one of the plurality of modules/units may be implemented through an AI model. The functions associated with AI may be performed by non-volatile memories, volatile memories, and processors.

The processor may comprise one or more processors. In this regard, the one or more processors may be general-purpose processors, such as central processing units (CPU), or application processors (AP), processors used only for graphics (such as graphics processors (GPU), visual processors (VPU) and/or AI-specific processors (e.g., neural processing units (NPU)).

The one or more processors control the processing of input data according to predefined operating rules or artificial intelligence (AI) models stored in non-volatile memories and volatile memories. The predefined operating rules or artificial intelligence models may be provided by training or learning, which means that a predefined operation rule or AI model having desired characteristics is formed by applying a learning algorithm to a plurality of learning data. The learning may be performed in an AI-performing device itself according to an embodiment, and/or may be implemented by a separate server/device/system.

As an example, an artificial intelligence model may comprise a plurality of neural network layers. Each layer has a plurality of weight values, and layer operation is performed through the calculation of the previous layer and the operation of the plurality of weight values. Examples of neural networks comprise but are not limited to convolutional neural networks (CNN), deep neural networks (DNN), recurrent neural networks (RNN), restricted Boltzmann machines (RBM), deep belief networks (DBN), bidirectional recursion deep neural networks (BRDNN), generative adversarial networks (GAN) and deep Q networks.

A learning algorithm is a method that a plurality of learning data is used to train a predetermined target device (e.g., a robot) to make, allow, or control the target device to make a determination or prediction. Examples of the learning algorithm comprise but are not limited to supervised learning, unsupervised learning, semi-supervised learning or reinforcement learning.

The method and apparatus for accessing the network cell according to the the exemplary embodiments of the present disclosure may improve the network cell access efficiency of the mobile terminal, by obtaining location information of the mobile terminal; obtaining second area information, before the mobile terminal arrives at a first area; and performing a network cell search and accessing a searched network cell based on the obtained second area information, in response to detecting that the mobile terminal enters the second area, where, the first area is an area without network service or an area with weak network service, and the second area is an area with normal network service on a travel route of the mobile terminal, and the mobile terminal enters the second area after passing through the first area.

In the method and apparatus for accessing the network cell according to the exemplary embodiments of the present disclosure, AI technology is used to intelligently predict target cell information and arrival time of the mobile communication terminal in advance to help the mobile communication terminal to quickly restore network services, or automatically adapt to the network changes, which may reduce waiting time for accessing the network, reduce unnecessary full-band scanning process, reduce battery power consumption, and improve the experience of the terminal user.

Although the present disclosure has been specifically shown and described with reference to its exemplary embodiments, those skilled in the art should understand that various changes in form and details may be made without departing from the spirit and scope of the present disclosure as defined by the claims.

1. A method for accessing, by a mobile terminal, a network cell, comprising:
obtaining location information of the mobile terminal;
obtaining second area information before the mobile terminal arrives at a first area; and
performing a network cell search and accessing a searched network cell based on the obtained second area information, in response to detecting that the mobile terminal enters the second area,
wherein the first area is an area without network service or an area with weak network service, and the second area is an area with normal network service on a travel route of the mobile terminal, and the mobile terminal enters the second area after passing through the first area.

2. The method according to claim 1, further comprising:
after obtaining the location information of the mobile terminal and before obtaining the second area information, predicting the first area and the second area to be passed through by the mobile terminal and first area information and the second area information, based on historical trip feature data of the mobile terminal and the location information of the mobile terminal.

3. The method according to claim 2, wherein the historical trip feature data comprises at least one of a route area, time information corresponding to the route area, route network information corresponding to the route area, user feature information, and traffic feature information.

4. The method according to claim 2,
wherein the predicting of the first area and the second area to be passed through by the mobile terminal and the first area information and the second area information comprises predicting the first area and the second area to be passed through by the mobile terminal and the first area information and the second area information when a condition for triggering the prediction is detected, and
wherein the condition for triggering the prediction comprises at least one of an expiration of a timing with a predetermined prediction period, a location change, a deviation from a trajectory, and a change in current network connection status.

5. The method according to claim 2, wherein the predicting of the first area and the second area to be passed through by the mobile terminal and first area information and second area information comprises predicting the first area and the second area to be passed through by the mobile terminal and the first area information and the second area information in a server or locally in the mobile terminal.

6. The method according to claim 2,
wherein the first area information comprises time required to pass through the first area under a preset condition, and
wherein the second area information comprises at least one of network cell information, network signal strength of the network cell, network coverage of the network cell, network connection speed, network type, and network access status of the second area.

7. The method according to claim 6, wherein the network cell information of the second area is information on a network cell which the mobile terminal prefers to access in the second area.

8. The method according to claim 1, further comprising:
after the obtaining the second area information, detecting whether the mobile terminal enters the second area, based on at least one of a positioning result of the mobile terminal, a network signal change of the mobile terminal, and time elapsed since the mobile terminal arrives at the first area.

9. The method according to claim 8, further comprising:
determining whether the mobile terminal arrives at the first area based on the positioning result of the mobile terminal.

10. An apparatus of a mobile terminal for accessing a network cell, comprising:
a processor; and
a memory storing a computer program, wherein the computer program, when executed by the processor, causes the processor to perform operations comprising:
obtaining location information of the mobile terminal,
obtaining second area information before the mobile terminal arrives at a first area, and
performing a network cell search and accessing a searched network cell based on the obtained second area information, in response to detecting that the mobile terminal enters the second area,
wherein the first area is an area without network service or an area with weak network service, and the second area is an area with normal network service on a travel route of the mobile terminal, and the mobile terminal enters the second area after passing through the first area.

11. The apparatus according to claim 10, wherein the operations further comprise:
after obtaining the location information of the mobile terminal and before obtaining the second area information, predicting the first area and the second area to be passed through by the mobile terminal and first area information and the second area information, based on historical trip feature data of the mobile terminal and the location information of the mobile terminal.

12. The apparatus according to claim 11, wherein the historical trip feature data comprises at least one of a route area, time information corresponding to the route area, route network information corresponding to the route area, user feature information, and traffic feature information.

13. The apparatus according to claim 11,
wherein the predicting of the first area and the second area to be passed through by the mobile terminal and the first area information and the second area information comprises predicting the first area and the second area to be passed through by the mobile terminal and the first area information and the second area information when a condition for triggering the prediction is detected, and
wherein the condition for triggering the prediction comprises at least one of an expiration of a timing with a predetermined prediction period, a location change, a deviation from a trajectory, and a change in current network connection status.

14. The apparatus according to claim 11, wherein the predicting of the first area and the second area to be passed through by the mobile terminal and first area information and second area information comprises predicting the first area and the second area to be passed through by the mobile terminal and the first area information and the second area information in a server or locally in the mobile terminal.

15. The apparatus according to claim 11,
wherein the first area information comprises time required to pass through the first area under a preset condition, and
wherein the second area information comprises at least one of network cell information, network signal strength of the network cell, network coverage of the network cell, network connection speed, network type, and network access status of the second area.

16. The apparatus according to claim 15, wherein the network cell information of the second area is information on a network cell which the mobile terminal prefers to access in the second area.

17. The apparatus according to claim 10, wherein the operations further comprise:
after the obtaining the second area information, detecting whether the mobile terminal enters the second area, based on at least one of a positioning result of the mobile terminal, a network signal change of the mobile terminal, and time elapsed since the mobile terminal arrives at the first area.

18. The apparatus according to claim 17, wherein the operations further comprise:
determining whether the mobile terminal arrives at the first area based on the positioning result of the mobile terminal.

19. A non-transitory computer readable storage medium storing instructions which, a processor of a mobile terminal, causes the mobile terminal to perform operations comprising:
obtaining location information of the mobile terminal;
obtaining second area information before the mobile terminal arrives at a first area; and
performing a network cell search and accessing a searched network cell based on the obtained second area information, in response to detecting that the mobile terminal enters the second area,
wherein the first area is an area without network service or an area with weak network service, and the second area is an area with normal network service on a travel route of the mobile terminal, and the mobile terminal enters the second area after passing through the first area.

20. The non-transitory computer readable storage medium according to claim 19, wherein the operations further comprise:
after obtaining the location information of the mobile terminal and before obtaining the second area information, predicting the first area and the second area to be passed through by the mobile terminal and first area information and the second area information, based on historical trip feature data of the mobile terminal and the location information of the mobile terminal.
